(19) United States
(12) Patent Application Publication
(10) Pub. No.: US 2025/0002386 A1
(43) Pub. Date: Jan. 2, 2025

(54) MEMBRANE BIOREACTOR SYSTEM FOR TREATING WASTEWATER USING OXYGEN

(71) Applicant: AMERICAN AIR LIQUIDE, INC., Fremont, CA (US)

(72) Inventors: Min Ho MAENG, Newark, DE (US); Rovshan MAHMUDOV, Newark, DE (US)

(73) Assignee: AMERICAN AIR LIQUIDE, INC., Fremont, CA (US)

(21) Appl. No.: 18/707,553

(22) PCT Filed: May 31, 2022
(86) PCT No.: PCT/US2022/031611

§ 371 Date: May 3, 2024

Related U.S. Application Data
(60) Provisional application No. 63/240,100, filed on Sep. 2, 2021.

(51) Int. Cl. C02F 9/00; C02F 3/12; C02F 3/28; C02F 3/30; C02F 101/10; C02F 101/16

(52) U.S. Cl. CPC C02F 9/00; C02F 3/121; C02F 3/1268; C02F 3/286; C02F 3/308; C02F 2101/105; C02F 2101/163; C02F 2301/046

(57) ABSTRACT

Systems and methods are disclosed for treating wastewater, such as food and beverage industry wastewater, pulp and paper wastewater, textile wastewater, tannery wastewater, pharmaceutical wastewater, etc., which contains high concentration of COD along with high concentrations of nitrogen and phosphorus to yield a low COD output along with a low phosphorous output and a low nitrogen output. One system comprises a buffer tank, an anoxic tank, an oxic tank, and a membrane bioreactor tank fluidically connected in series with pure oxygen blown into the oxic tank.

### CROSS REFERENCE TO RELATED APPLICATIONS

This application is a § 371 of International PCT Application PCT/US2022/031611, filed May 31, 2022, which claims priority to U.S. patent application 63/240,100, filed Sep. 2, 2021.

### FIELD OF THE INVENTION

The present invention relates to pure oxygen based membrane bioreactor (MBR) systems and methods of using the pure oxygen based MBR systems for treating wastewater, such as food and beverage industry wastewater, pulp and paper wastewater, textile wastewater, tannery wastewater, pharmaceutical wastewater, etc., which contains high contents of organics, in particular, the disclosed pure oxygen based MBR systems and methods relate to treat the wastewater containing high concentration of chemical oxygen demand (COD) components and high concentrations of nitrogen, and/or phosphorus contained in the COD.

### BACKGROUND

Biological wastewater treatment systems, e.g. activated sludge processes, utilize microorganisms to treat biodegradable contaminants from wastewater. Membrane bioreactor (MBR) system is an advanced wastewater treatment system that replaces a large secondary sedimentation basin with dense microfiltration (MF), ultrafiltration (UF) or nanofiltration (NF) membrane modules for complete biosolids-liquid separation. Porous membrane structure allows the passage of biologically treated wastewater towards a permeate side while retaining biosolids in a feed side. The membrane modules may be submerged inside a bioreactor or outside the bioreactor.

One of the most challenging aspects in operating MBR systems is the control of membrane fouling, which is a key factor affecting the lifespan of membrane. Deposition of the membrane foulants containing biosolids and soluble microbial products (SMP) on the membrane surface is inevitable in the course of the treated permeate filtration across the membrane structure. As the membrane foulants form a sludge cake layer on the membrane surface, the membrane permeability declines over time to maintain constant permeate flux while the transmembrane pressure increases. To avoid the rapid drop of the membrane permeability, membrane fouling is typically controlled by introducing air with a high velocity (parallel direction) to scour the membrane surface. When membrane fouling becomes severe and the operating permeate flux decreases below a critical level, the thickened sludge cake layer on the membrane surface is removed physically and chemically to recover the membrane permeability.

The membrane foulants are oxidizable organic matters produced through a metabolism of wastewater microorganisms residing in the bioreactors. One solution to reduce the membrane foulants production is to improve removal efficiency of biodegradable organics. Wastewater microorganisms oxidize most of organics biologically using oxygen molecules under aerobic (or oxic) and anoxic conditions. Aerobic microorganisms utilize dissolved oxygen molecules, while anoxic microorganisms utilize bound-oxygen molecules in nitrate.

US 2014/0332464 to Fabiyi et al. discloses a method of controlling dissolved oxygen levels in a secondary treatment system of a wastewater treatment facilities that employ membrane bioreactor system for preventing mixed liquor bulking and minimizing generation of extracellular polymeric substances.

WO 2012/177907 to Billingham et al. discloses a high pressure oxygen supply method to the wastewater treatment system with a supercritical water oxidation reactor for handling waste sludge produced from the wastewater treatment plant. An air separation unit also generates gaseous oxygen and/or air for the biological wastewater treatment in a biological basins.

US 2013/0001142 to Novak et al. discloses an advanced control system for the membrane bioreactor to treat wastewater and mentioned the use of high purity oxygen.

US 2009/0050552 to Novak et al. discloses the activated sludge wastewater treatment system with high dissolved oxygen levels.

US 2008/0078719 to Fabiyi et al. discloses a system for the wastewater treatment system combining a high selectivity reactor where ozone-enriched gas achieves selective treatment of a liquid stream diverted from the wastewater treatment reactor.

US 2014/0124457 to Boussemaere et al. discloses a method of treating animal waste using high purity oxygen by increasing the dissolved oxygen concentration of the liquid fraction. More specifically, US 2014/0124457 discloses animal waste as a target feed waste to be treated by maintaining the dissolved oxygen level between 2 mg and 9 mg per liter in the liquid fraction.

U.S. Pat. No. 6,962,654 B2 to Arnaud discloses a method and apparatus for supplying dissolved gasses for the biodegradation of municipal and industrial wastewater. The dissolved gases include oxygen, ozone, chlorine etc.

Known MBR systems require an energy-intensive aeration for physical membrane scouring and biological wastewater contaminant oxidation which typically account for more than half of the total power consumption in a full-scale application. In addition, the cost of cleaning and replacing the membrane modules is one of the main operating expense (OPEX) components.

Thus, a need remains for effective reduction and removal of fouling in MBR for wastewater treatment.

### SUMMARY

There is disclosed a system for treating a wastewater that contains high concentration of chemical oxygen demand (COD), high concentration of nitrogen and high concentration of phosphorus to yield a low COD output along with a low phosphorous output and a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
an anaerobic tank, located downstream of, and being fluidically connected to, the buffer tank, comprising the buffered sludge stream, configured and adapted to release a phosphorous contained in the buffered sludge stream to phosphate ions (PO₄³⁻) by phosphorus accumulating organisms (PAOs) in the anaerobic tank yielding a phosphorous-released sludge stream;
an anoxic tank comprising the phosphorous-released sludge stream and located downstream of, and being fluidically connected to the anaerobic tank, configured and adapted to enable uptake of the released phosphate ions (PO₄³⁻) contained in the phosphorous-released sludge stream by wastewater microorganisms in the anoxic tank, yielding a low phosphorous output sludge stream;
an oxic tank, located downstream of, and being fluidically connected to the anoxic tank, comprising the low phosphorous output sludge stream and a pressurized pure oxygen, the oxic tank configured and adapted to enable a further oxidization of the soluble organic components contained in the low phosphorous output sludge stream and to convert the nitrogen contained in the low phosphorous output sludge stream to nitrate ions;
an internal sludge recycle line fluidically connecting the oxic tank and the anoxic tanks, the internal sludge recycle line configured and adapted to recycle a nitrate-enriched liquor from the oxic tank as an internal sludge recycle stream to the anoxic tank for denitrification, thereby, yielding a low COD output, low nitrogen output and low phosphorous output sludge stream from the oxic tank;
an injection subsystem operably connected to the oxic tank and configured and adapted to inject the pressurized pure oxygen into the oxic tank;
a membrane bioreactor tank, located downstream of and being fluidically connected to the oxic tank, comprising the low COD output, low nitrogen output and low phosphorous output sludge stream and a plurality of membrane modules submerged in the low COD output, low nitrogen output and low phosphorous output sludge stream, the plurality of membrane modules configured and adapted to filter out a treated wastewater having the low COD output, low phosphorous output and low nitrogen output thereby forming the sludge stream; and
a sludge recycle line configured and adapted to recycle at least a portion of the sludge stream containing the residual dissolved oxygen back to the buffer tank;

There is also disclosed a method for treating a wastewater that contains high concentration of COD, high concentration of nitrogen and high concentration of phosphorus to yield a low COD output along with a low phosphorous output and a low nitrogen output, the method comprising the steps of
a) mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b) releasing phosphorous contained in the liquid phase of the wastewater in the buffered sludge stream to phosphate ions (PO₄³⁻) in an anaerobic tank, thereby yielding a phosphorous-released sludge stream;
c) uptaking the released phosphate ions (PO₄³⁻) contained in the phosphorous-released sludge stream in an anoxic tank yielding a low phosphorous output sludge stream;
d) transferring the low phosphorous output sludge stream from the anoxic tank to an oxic tank, injecting pressurized pure oxygen into the oxic tank and recycling a nitrate-enriched liquor from the oxic tank as an internal sludge recycle stream to the anoxic tank for denitrification, thereby yielding a low COD output, low nitrogen output and low phosphorous output sludge stream from the oxic tank;
e) forwarding the low COD output, low nitrogen output and low phosphorous output sludge stream to a membrane bioreactor tank;
f) filtering out a treated wastewater having the low COD output, low phosphorous output and low nitrogen output with membrane modules submerged in the membrane bioreactor tank, thereby also producing the sludge stream; and
g) feeding the sludge stream containing the residual dissolved oxygen from the membrane bioreactor back to the buffer tank in the step a).

There is also disclosed a system for treating a wastewater that contains high concentration of COD, high concentration of nitrogen and low concentration of phosphorous to yield a low COD output along with a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
a nitrification and denitrification loop comprising
   an anoxic tank comprising the buffered sludge stream and located downstream of, and being fluidically connected to, the buffer tank;
   an oxic tank, located downstream of, and being fluidically connected to, the anoxic tank, comprising the buffered sludge stream and pressurized pure oxygen; and
   an injection subsystem operably connected to the oxic tank and configured and adapted to inject the pressurized pure oxygen into the oxic tank,
      wherein the nitrification and denitrification loop is configured and adapted to further oxidize soluble organic components contained in the buffered sludge stream and to convert the nitrogen contained in the buffered output sludge stream to nitrate ions by recycling a nitrate-enriched liquor from the oxic tank as an internal sludge recycle stream to the anoxic tank for denitrification, thereby, yielding a low COD output and low nitrogen output sludge stream;
a membrane bioreactor tank, located downstream of and being fluidically connected to the oxic tank, comprising the low COD output and low nitrogen output sludge stream and a plurality of membrane modules, the plurality of membrane modules configured and adapted to filter out a treated wastewater having the low COD output and low nitrogen output thereby forming the sludge stream; and
a sludge recycle line configured and adapted to recycle at least a portion of the sludge stream containing the residual dissolved oxygen back to the buffer tank;
There is also disclosed a method for treating a wastewater that contains high concentration of COD, high concentration of nitrogen and low concentration of phosphorous to yield a low COD output along with a low nitrogen output, the method comprising the steps of:
a) mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b) feeding the buffered sludge stream to an anoxic tank fluidly connected to the buffer tank;
c) transferring the buffered sludge stream from the anoxic tank to an oxic tank, injecting pressurized pure oxygen into the oxic tank;
d) recycling a nitrate-enriched liquor from the oxic tank as an internal sludge recycle stream to the anoxic tank to convert the nitrogen contained in the buffered sludge stream to nitrate ions, thereby yielding a low COD output and low nitrogen output sludge stream from the oxic tank;
e) filtering out a treated wastewater having the low COD output and low nitrogen output with membrane modules submerged in a membrane bioreactor tank, thereby also producing the sludge stream;
f) feeding the sludge stream containing the residual dissolved oxygen discharged from the membrane bioreactor back to the buffer tank in the step a);
There is also disclosed a system for treating a wastewater that contains high concentration of COD, low concentration of nitrogen and low concentration of phosphorous to yield a low COD output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
an oxic tank, located downstream of, and being fluidically connected to, the buffer tank, comprising the buffered sludge stream and pressurized pure oxygen, the oxic tank configured and adapted to enable a further oxidation of the soluble organic components contained in the buffer sludge stream, thereby, yielding a low COD output, low nitrogen output and low phosphorous output sludge stream;
a membrane bioreactor tank, located downstream of and being fluidically connected to, the oxic tank, comprising the low COD output, low nitrogen output and low phosphorous output sludge stream and a plurality of membrane modules, the plurality of membrane modules configured and adapted to filter out a treated wastewater having the low COD output, low phosphorous output and low nitrogen output thereby forming the sludge stream; and
a sludge recycle line configured and adapted to recycle at least a portion of the sludge stream containing the residual dissolved oxygen back to the buffer tank;
There is also disclosed a method for treating a wastewater that contains high concentration of COD, low concentration of nitrogen and low concentration of phosphorous to yield a low COD output, the method comprising the steps of:
a) mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b) transferring the buffered sludge stream from the buffered tank to an oxic tank, simultaneously injecting pressurized pure oxygen into the oxic tank, thereby yielding a low COD output, low nitrogen output and low phosphorous output sludge stream from the oxic tank;
c) filtering out a treated wastewater having the low COD output, low nitrogen output and low phosphorous output sludge stream with membrane modules submerged in a membrane bioreactor tank, thereby also producing the sludge stream; and
d) feeding the sludge stream containing the residual dissolved oxygen from the membrane bioreactor back to the buffer tank in the step a).

There is also disclosed a system for treating a wastewater that contains high concentration of COD, low concentration of nitrogen and high concentration of phosphorous to yield a low COD output along with a low phosphorous output and a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream and to release phosphorous contained in the liquid phase of the wastewater to phosphate ions (PO₄³⁻) by phosphorus accumulating organisms (PAOs), thereby, forming a buffered low phosphorous output sludge stream;
an oxic tank, located downstream of, and being fluidically connected to, the buffer tank, comprising the buffered low phosphorous output sludge stream and pressurized pure oxygen, the oxic tank configured and adapted to enable a further oxidation of the soluble organic components contained in the buffered low phosphorous output sludge stream, thereby, yielding a low COD output, low nitrogen output and low phosphorous output sludge stream;
an injection subsystem operably connected to the oxic tank and configured and adapted to inject the pressurized pure oxygen into the oxic tank;
a membrane bioreactor tank, located downstream of and being fluidically connected to the oxic tank, comprising the low COD output, low nitrogen output and low phosphorous output sludge stream and a plurality of membrane modules, the plurality of membrane modules configured and adapted to filter out a treated wastewater having the low COD output, low phosphorous output and low nitrogen output thereby forming the sludge stream; and
a sludge recycle line configured and adapted to discharging recycle at least a portion of the sludge stream containing the residual dissolved oxygen back to the buffer tank;
There is also disclosed a method for treating a wastewater that contains high concentration of COD, low concentration of nitrogen and high concentration of phosphorous to yield a low COD output along with a low phosphorous output, the method comprising the steps of:
a) mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater and to release phosphorous contained in the liquid phase of the wastewater to phosphate ions (PO₄³⁻), thereby, forming a buffered low phosphorous output sludge stream;
b) transferring the buffered low phosphorous output sludge stream from the buffered tank to an oxic tank, simultaneously injecting pressurized pure oxygen into the oxic tank to oxidize the soluble organic components contained in the buffered low phosphorous output sludge stream, yielding a low COD output and low phosphorous output sludge stream from the oxic tank;
c) filtering out a treated wastewater having the low COD output and low phosphorous output with membrane modules submerged in the membrane bioreactor tank, thereby also producing the sludge stream; and
d) feeding the sludge stream containing the residual dissolved oxygen from the membrane bioreactor back to the buffer tank in the step a);

There is also disclosed a system for treating a wastewater that contains high concentration of COD to yield a low COD output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream; and
a membrane bioreactor tank, located downstream of and being fluidically connected to, the buffer tank, comprising the buffered sludge stream, a plurality of membrane modules submerged in the buffer sludge stream and pressurized pure oxygen, the membrane bioreactor tank configured and adapted to i) further oxidize the soluble organic components contained in the buffered sludge stream forming the low COD output, ii) to filter out a treated wastewater having the low COD output, and iii) to discharge the sludge stream containing the residual dissolved oxygen recycled back to the buffer tank via a sludge recycle line;
There is also disclosed a method for treating a wastewater that contains high concentration of COD to yield a low COD output, the method comprising the steps of:
a) mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b) transferring the buffered sludge stream from the buffered tank to a membrane bioreactor tank, simultaneously injecting pressurized pure oxygen into the membrane bioreactor tank, thereby yielding a low COD output sludge stream therein;
c) filtering out a treated wastewater having the low COD output with membrane modules submerged in the membrane bioreactor tank, thereby also producing the sludge stream; and
d) feeding the sludge stream containing the residual dissolved oxygen from the membrane bioreactor back to the buffer tank in the step a);

In some embodiments the buffer tank further comprises PAOs therein and wherein the phosphorous contained in the liquid phase of the wastewater is also capable of being released to the phosphate ions (PO₄³⁻) by the PAOs in the buffer tank;

In some embodiments the pressurized pure oxygen has a purity of 99.99% by volume;

In some embodiments a dissolved oxygen concentration in the oxic tank ranges from approximately 2 mg/L to approximately 6 mg/L;

In some embodiments a dissolved oxygen concentration in the oxic tank ranges from approximately 2 mg/L to approximately 5 mg/L;

In some embodiments a dissolved oxygen concentration in the oxic tank ranges from approximately 4 mg/L to approximately 6 mg/L;

In some embodiments the membrane module is a flat-sheet membrane module or a hollow fiber membrane module;

In some embodiments a mixed liquor suspended solids in the membrane tank is between approximately 5000 mg and approximately 15000 mg of total suspended solids per liter;

In some embodiments, the wastewater includes industry wastewater, pulp and paper wastewater, textile wastewater, tannery wastewater, pharmaceutical wastewater, etc.;

In some embodiments a flow rate of the nitrate-enriched liquor recycled to the anoxic tank is approximately 5 times larger than a flow rate of the liquid phase of the wastewater feeding into the buffer tank, thereby maintaining a low concentration of nitrogen in the oxic tank;

In some embodiments a sludge retention time is maintained between approximately 40 days to approximately 60 days;

In some embodiments an average effective hydraulic retention time is between approximately 3 hours to approximately 5 hours.

### Notation and Nomenclature

The following detailed description and claims utilize a number of abbreviations, symbols, and terms, which are generally well known in the art. While definitions are typically provided with the first instance of each acronym, for convenience, Table 1 provides a list of the abbreviations, symbols, and terms used along with their respective definitions.

TABLE 1

| | |
|---|---|
| COD | Chemical Oxygen Demand |
| BOD | Biological Oxygen Demand |
| SMP | Soluble Microbial Products |
| MBR | Membrane Bioreactor |
| OUR | Oxygen Uptake Rate |
| PAO | Phosphorus Accumulating Organisms |
| PVDF | Polyvinylidene Fluoride |
| SCOD | Soluble Chemical Oxygen Demand |
| LMH | L/m² · h |
| F/M ratio | Food to Microorganism ratio |
| OLR | Organic Loading Rate |
| HRT | Hydraulic Retention Time |
| SRT | Sludge Retention Time |
| PLC | Programmable Logic Controller |
| DO | Dissolved Oxygen |
| MLSS | Mixed Liquor Suspended Solids |
| CLSM | Confocal Laser Scanning Microscopy |
| OTR | Oxygen Transfer Rate |
| HPO | High Purity Oxygen |
| TMP | Transmembrane Pressure |
| PBS | Phosphate Buffer Solution |
| EPS | polymeric substance |
| TN | Total Nitrogen |
| TP | Total Phosphorus |

The singular forms “a”, “an” and “the” include plural referents, unless the context clearly dictates otherwise.

As used herein, “about” or “around” or “approximately” in the text or in a claim means±10% of the value stated.

As used herein, “room temperature” in the text or in a claim means from approximately 20° C. to approximately 25° C.

The term “wastewater” refers to an influent wastewater containing at least one of organic components among approximately 250 mg/L to approximately 160000 (160K) mg/L of COD, approximately 10 mg/L to approximately 1500 mg/L of total nitrogen and approximately 10 mg/L to approximately 1000 mg/L of total phosphorus (i.e., PO₄³⁻). Exemplary wastewater includes food and beverage industry wastewater, pulp and paper wastewater, textile wastewater, tannery wastewater, pharmaceutical wastewater, etc.

The term “high concentration of COD” or “high COD concentration” or “high COD” in the text or in a claim refers to approximately 250 mg/L to approximately 160K mg/L of COD.

The term “high concentration of nitrogen” in the text or in a claim refers to approximately 10 mg/L to approximately 1500 mg/L of total nitrogen.

The term “high concentration of phosphorus” in the text or in a claim refers to approximately 10 mg/L to approximately 1000 mg/L of total phosphorus (i.e., PO₄³⁻).

The term “high concentration of wastewater” refers to the wastewater containing high concentrations of COD, nitrogen, and/or phosphorus.

The term “low concentration of COD” refers to less than approximately 250 mg/L of COD.

The term “low concentration of N” refers to less than approximately 10 mg/L of total nitrogen.

The term “low concentration of P” refers to less than approximately 10 mg/L of total phosphorus (i.e., PO₄³⁻).

The term “pure oxygen” used herein refers to a purity of oxygen gas is 99.9% or more, preferably 99.99% or more.

The term “steady condition” or “steady state condition” or “steady operation” or “steady state operation” refers to a condition in which a concentration of dissolved oxygen in an aeration system remains approximately the same over time. When the aeration system attains “steady state condition” in a continuous operation mode, a body of the sludge suspension may have different concentrations of dissolved oxygen along the height of the body of the sludge suspension. However, the concentration values would remain approximately constant with addition of oxygen molecules over time.

The standard abbreviations of the elements from the periodic table of elements are used herein. It should be understood that elements may be referred to by these abbreviations (e.g., Si refers to silicon, N refers to nitrogen, O refers to oxygen, C refers to carbon, H refers to hydrogen, F refers to fluorine, etc.).

The unique CAS registry numbers (i.e., “CAS”) assigned by the Chemical Abstract Service are provided to identify the specific molecules disclosed.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range.

### BRIEF DESCRIPTION OF THE FIGURES

For a further understanding of the nature and objects of the present invention, reference should be made to the following detailed description, taken in conjunction with the accompanying drawings, in which like elements are given the same or analogous reference numbers and wherein:

FIG. 1 is a block flow diagram of exemplary embodiments of a MBR system for treating wastewater containing COD along with P and N;

FIG. 2 is a block flow diagram of an exemplary embodiment of a system for treating wastewater containing high COD concentration;

FIG. 3 is a block flow diagram of an exemplary embodiment of an aerobic MBR pilot system;

FIG. 4 is a block flow diagram of exemplary embodiments of a side-stream pure oxygen injection device;

FIG. 5 is aerobic MLSS Zeta potential at various aeration methods; and

FIG. 6 is TMP profile through MLSS Zeta potential with different aeration methods.

### DESCRIPTION OF PREFERRED EMBODIMENTS

Disclosed are pure-oxygen based membrane bioreactor (MBR) systems and methods for treating wastewater, such as food and beverage industry wastewater, pulp and paper wastewater, textile wastewater, tannery wastewater, pharmaceutical wastewater, etc., which contains high contents of organics, such as, chemical oxygen demand (COD) components, along with high concentration of phosphorous and nitrogen. The food and beverage industry wastewater includes the wastewater from brewery, winery, dairy, meat processing, fish processing, sugar beet, etc. In particular, the disclosed MBR systems and methods include treating the wastewater containing high concentrations of COD along with high concentrations of nitrogen and/or phosphorus using pure oxygen. The disclosed MBR systems and methods include treating high concentration of wastewater containing high concentrations of COD along with high concentrations of nitrogen and/or phosphorus using pure oxygen.

The disclosed systems and methods comprise injecting pressurized pure oxygen into an oxic basin rather than air blowing, thereby, reducing the total amount of oxygen supplied to the system and improving the membrane permeability in treating wastewater. This improves efficiency of oxygen usage for wastewater oxidation and enhances efficiency of membrane foulant removal to achieve a cost-effective MBR process. Furthermore, injecting the pressurized pure oxygen into the oxic basin reduces the requirements of oxygen molecules for the biological wastewater removal and extends a cycle of the membrane module to be cleaned and replaced.

It is known that a rate of organic removal through oxidization is proportional to OUR, which may be improved by increasing the concentration of dissolved oxygen molecules in a liquid phase. Pressurized pure oxygen provides higher feed gas pressure and saturation level than compressed air gas supplied by a known air blowing method, which may improve the dissolution efficiency of oxygen molecules from a gas phase to the liquid phase. An enhanced transfer rate of oxygen molecule by pure oxygen gives aerobic microorganisms more chance to utilize oxygen molecules to oxidize the membrane foulants than oxygen supplied from compressed air blowing.

Monitoring and controlling COD in wastewater is important in controlling the amount of nitrogen and phosphorus in the water. Normally COD, total N, and total P are monitored simultaneously. COD level as well as nitrogen and phosphorus levels must comply with environmental regulations. A goal for treating wastewater is to remove as much COD along with nitrogen and phosphorous as possible from the wastewater. The disclosed pure oxygen-based MBR systems feature: i) removing COD, nitrogen, and phosphorus with improved membrane permeability; ii) enhancing OUR at the wastewater phase in an oxic basin, and iii) comprising of a buffer, anaerobic, anoxic, oxic, and membrane submerged basins installed in series with recycling a sludge stream from the oxic basin to the anoxic basin and/or with recycling a sludge stream from the membrane submerged basin to the buffer basin for a favorable biological nutrients removal.

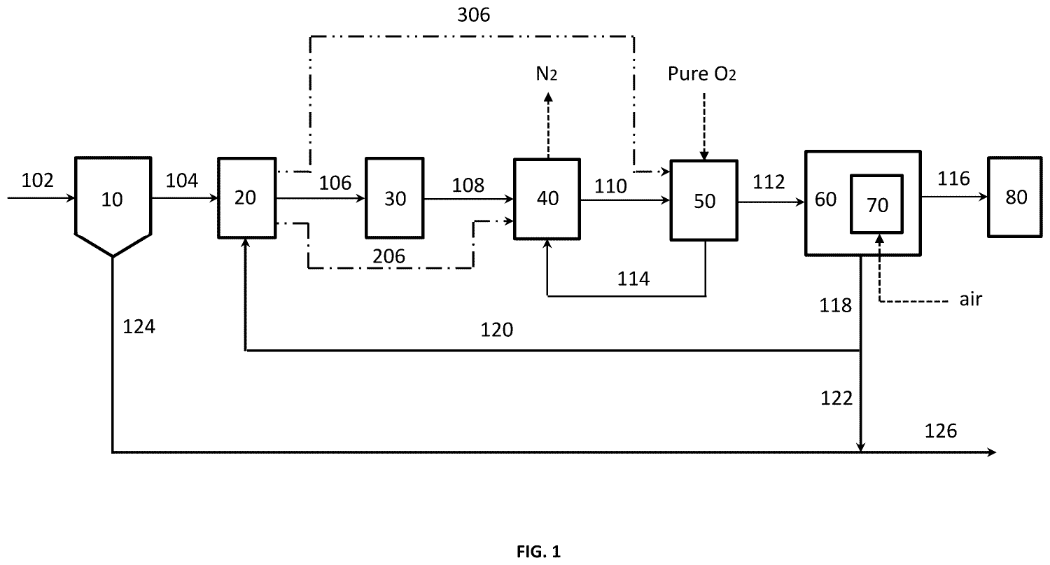

FIG. 1 is a block flow diagram of exemplary embodiments of a MBR wastewater treatment system for treating wastewater containing COD along with P and N. As shown, an influent wastewater 102 is fed to a primary treatment unit 10, where the influent wastewater 102 is separated into a primary sludge fraction 124 and a liquid fraction 104. In one embodiment, the influent wastewater 102 may contain high concentration of COD ranging from approximately 250 mg/L to approximately 160K mg/L, high concentration of nitrogen ranging from approximately 10 mg/L to 1500 mg/L, and high concentration of phosphorous ranging from approximately 10 mg/L to 1000 mg/L. The primary treatment unit 10 may be a single settler, or two or more process units combined together depending on the wastewater characteristics. The examples of the primary treatment unit 10 include screens, a grinder, a grit basin and the like. The primary sludge fraction 124 includes floating debris, grits, suspended solids and the like. The primary sludge fraction 124 may be combined with a first sludge portion 122 of a secondary sludge stream 118 from a membrane basin 60 (described below) to form a sludge stream 126 for further post-treatment or disposal.

The liquid fraction 104 from the primary treatment unit 10 contains soluble organic compositions, such as COD along with phosphorous and nitrogen. The concentration of COD may range from approximately 250 mg/L to approximately 160K mg/L, the concentration of nitrogen may range from approximately 10 mg/L to 1500 mg/L, and the concentration of phosphorus may range from approximately 10 mg/L to 1000 mg/L. The liquid fraction 104 is fed to a buffer basin 20, where the liquid fraction 104 is mixed with a second sludge portion 120 of the secondary sludge stream 118 from the membrane basin 60 with a mechanical impeller (not shown) installed in the buffer basin 20. The buffer basin 20 consumes a residual dissolved oxygen recycled with the second sludge portion 120 of the secondary sludge stream 118 from the membrane basin 60 to reduce soluble organic components in the liquid phase. The amount of mixed liquor suspended solids (MLSS) is high (see below) in the secondary sludge stream 118 so that a sufficient amount of wastewater microorganisms is provided into the buffer basin 20 to allow removals of the soluble organic matters using the residual dissolved oxygen. Thus, carbon in the COD is oxidized in the buffer basin 20 with the residual oxygen in the second sludge portion 120.

A sludge stream 106 out of the buffer basin 20 having a negligible amount of dissolved oxygen is fed to an anoxic basin 30 so that a stable anaerobic condition is maintained therein in order to allow phosphate ions (PO₄³⁻) to be released and COD to be stored as polyhydroxyalkanoates (PHAs) at the same time by phosphorus accumulating organisms (PAOs). A part of COD may be consumed in the anoxic basin 30 by heterotrophic microorganisms. The released phosphate ions (PO₄³⁻) contained in a sludge stream 108 are uptaken by ordinary wastewater microorganisms in an anoxic basin 40 and an oxic basin or an aerobic basin 50, thereby, a low phosphate concentration is maintained in a sludge stream 112 after the oxic basin 50 and phosphorus is removed from the influent wastewater 102 after the oxic basin 50. In one embodiment, if increasing the size of the buffer basin 20, phosphorus in the liquid phase of the wastewater may be released in the buffer tank by phosphorus accumulating organisms (PAOs) and the anoxic basin 30 may be bypassed. Furthermore, a part of COD may be oxidized in the anoxic 40 and the oxic basin 50 by heterotrophic microorganisms. Particularly, the organic carbon in the COD is oxidized with binding oxygen in nitrate in the anoxic basin 40 and oxidized with injected pure oxygen in the oxic basin 50.

Here a pressurized pure oxygen gas is injected into the oxic basin 50 instead of a compressed air. The pure oxygen gas has a purity of 99.9%, preferably 99.99%. A dissolved oxygen concentration in the oxic basin 50 ranges from approximately 2 mg to approximately 5 mg of oxygen per liter. Nitrogen source in the fed influent wastewater 102 is converted into nitrate ions in the oxic basin 50 with the injected pressurized pure oxygen. A nitrate-enriched liquor 114 containing the nitrate ions is then recycled as an internal sludge recycle stream to the anoxic basin 40 for denitrification, where the nitrate ions are reduced to inert nitrogen gas that vents out from the anoxic basin 40. In this way, the anoxic basin 40 and the oxic basin 50 forms a nitrification and denitrification loop. In addition to reduction of nitrogen, the nitrification and denitrification loop also reduces foulant concentration in the sludge stream 112 coming out of the oxic basin 50, which may be demonstrated in SMP results that may be seen from the examples that follow. The sludge stream 108 passing the anoxic basin 40 becomes the sludge stream 110 having the certain amount of the soluble organic matters that recycles back to the anoxic basin 40 with the nitrate-enriched liquor 114. The rest of organic matters in the liquid fraction 104 and stored organic matters by PAOs in a sludge stream 110 are oxidized in the oxic basin 50 with the injected pressurized pure oxygen. Thus, the sludge stream 112 contains low concentrations of organic matters of phosphorous and nitrogen and passes to the membrane basin 60. The remaining COD may be oxidized in the membrane basin 60 by heterotrophic microorganisms. Here a flow rate of the nitrate-enriched liquor 114 is set higher than a flow rate of the influent wastewater 102. For example, the flow rate of the nitrate-enriched liquor 114 is set 5 times higher than a flow rate of the influent wastewater 102. In this way, low nitrate ion concentration may be maintained in the sludge stream 112. Furthermore, the sludge stream 112 may contain large particles that favor the reduction of foulants in the membrane modules.

In some embodiments, a sludge retention time (SRT) may be between approximately 40 days to approximately 60 days. With this SRT, MLSSs between approximately 8000 mg and approximately 15000 mg of total suspended solids per liter are formed in the oxic basin 50 and the membrane basin 60.

A treated wastewater stream 116 is filtered out by the membrane module 70 submerged in the membrane basin 60, while the secondary sludge stream 118 is a wasted sludge from the membrane basin 60. The secondary sludge stream 118 containing the residual dissolved oxygen from the oxic basin 50 is then split into two portions, the first sludge portion 122 and the second sludge portion 120. The first sludge portion 122 combines with the primary sludge fraction 124 forming the sludge stream 126 for further post-treatment or disposal. The second sludge portion 120 containing the residual dissolved oxygen from the oxic basin 50 is fed back to the buffer basin 20 where the second sludge portion 120 mixes with the liquid fraction 104 of the influent wastewater 102. The buffer basin 20 reduces the soluble organic components in the liquid fraction 104 by consuming the residual dissolved oxygen recycled with the second sludge portion 120 of the secondary sludge stream 118 from the membrane basin 60. The treated wastewater stream 116 is transported to a discharge 80 for collection.

The membrane basin 60 includes a plurality of the micro-porous membrane module 70, preferably, two micro-porous membrane modules, submerged in the membrane basin 60. The membrane basin 60 includes a coarse bubble air diffuser (not shown), placed at the bottom of the membrane modules 70, to generate a cross-flow of air bubbles with air blown into the membrane basin 60 to scour a sludge flocs deposited on membrane surfaces of the membrane modules 70. The membrane modules 70 may be a flat-sheet membrane module, a hollow fiber membrane module, or the like. For a laboratory-scale testing, a flat sheet polyvinylidene fluoride (PVDF) membrane, may be used. In some embodiments, an average effective hydraulic retention time (HRT) of the pure oxygen based MBR system is between about approximately 3 hours to approximately 5 hours. Normal concentrations of nitrogen and phosphorus are metabolized in the buffer basin 20 with the residual dissolved oxygen from the membrane basin 60. A programmable logic controller (PLC) is designed and installed to control the entire MBR system (not shown).

In another embodiment, the influent wastewater 102 may contain high concentration of COD ranging from approximately 250 mg/L to approximately 160K mg/L, high concentration of nitrogen ranging from approximately 10 mg/L to approximately 1500 mg/L, but low concentration of phosphorous less than approximately 10 mg/L. In this embodiment, because the concentration of phosphorous is lower than the concentration threshold that requires P to be removed, the anoxic basin 30 may be eliminated or bypassed and the sludge stream (numeral label 206) may bypass the anoxic basin 30 and directly feed to the anoxic basin 40 for a nitrification and denitrification process to remove nitrogen, as shown in FIG. 1 dash-dotted line.

In another embodiment, the influent wastewater 102 may contain high concentration of COD ranging from approximately 250 mg/L to approximately 160K mg/L, but low concentration of nitrogen less than approximately 10 mg/L and low concentration of phosphorous less than approximately 10 mg/L. In this case, because the concentrations of phosphorous and nitrogen, respectively, are lower than the concentration thresholds that require P and/or N to be removed, both the anoxic basin 30 and the anoxic basin 40 may be eliminated or bypassed and the sludge stream (numeral label 306) may bypass the anoxic basin 30 and the anoxic basin 40 and directly feed to the oxic basin 50 for removing the COD, as shown in FIG. 1 dash-double-dotted line 306.

In another embodiment, the influent wastewater 102 may contain high concentration of COD ranging from approximately 250 mg/L to approximately 160K mg/L, low concentration of nitrogen less than approximately 10 mg/L, but high concentration of phosphorous ranging from approximately 10 mg/L to approximately 1500 mg/L. In this embodiment, both the anoxic basin 30 and the anoxic basin 40 may be eliminated or bypassed and the sludge stream (numeral label 306) may bypass the anoxic basin 30 and the anoxic basin 40 and directly feed to the oxic basin 50 for removing the COD, as shown in FIG. 1 dash-double-dotted line. However, in this case, without the anoxic basin 30, the size of the buffer basin 20 may be increased for the PAOs selection for the biological phosphorus release/uptake so that the high concentration of phosphorus is removed by the PAOs in the oxic basin 50, whereas the low concentration of nitrogen is metabolized by ordinary wastewater microorganisms in the buffer basin 20 and the oxic basin 50.

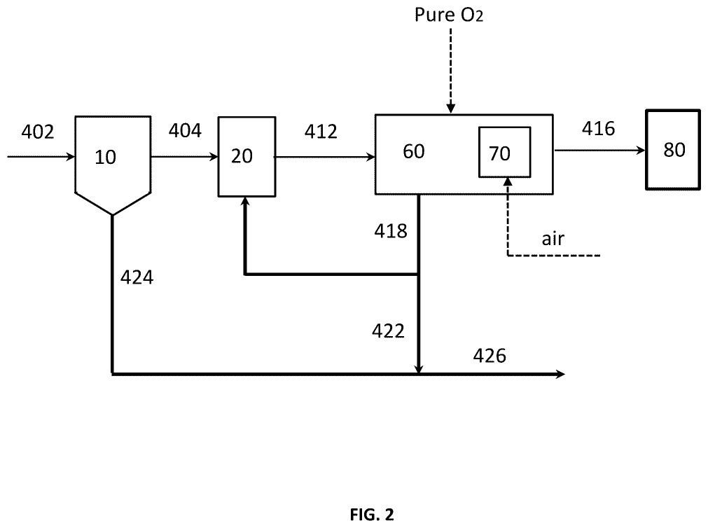

FIG. 2 is a block flow diagram of an exemplary embodiment of a MBR system for treating wastewater containing high COD concentration. In some cases, the wastewater treatment may only focus on treating the wastewater having the high concentration of COD and normal concentrations of nitrogen and phosphorus. Here the normal concentrations of nitrogen and phosphorus mean the concentrations of nitrogen and phosphorus each may comply with environmental regulations. In this case, an influent wastewater 402 is fed to the primary treatment unit 10, where the influent wastewater 402 is separated into a primary sludge fraction 424 and a liquid fraction 404. The influent wastewater 402 may contain high concentration of COD ranging from approximately 250 mg/L to approximately 160K mg/L. The primary sludge fraction 424 includes floating debris, grits, suspended solids and the like. The primary sludge fraction 424 may be combined with a first sludge portion 422 of a secondary sludge stream 418 from a membrane basin 60 to form a sludge stream 426 for further post-treatment or disposal. In this case, the normal concentrations of nitrogen and phosphorus are metabolized in the buffer basin 20. The anoxic basin 30, the anoxic basin 40 and the oxic basin 50 shown in FIG. 1 may be bypassed in this embodiment and the membrane bioreactor basin 60 is expanded for sufficient COD removal by aerobic microorganisms. Because there is no oxic basin in this embodiment, pure oxygen is blown into the membrane bioreactor basin 60 for the metabolization process. Similarly, a coarse bubble air diffuser (not shown), may be placed at the bottom of the membrane modules 70, to generate a cross-flow of air bubbles with air blown into the membrane bioreactor basin 60 to scour a sludge flocs deposited on membrane surfaces of the membrane modules 70.

The disclosed MBR system for treating high COD wastewater has been operated through a pilot-scale MBR system to treat real brewery wastewater and/or high concentration of wastewater or high COD concentration wastewater. The pilot-scale MBR was operated to validate the benefits of pure oxygen in treating the real wastewater. Under steady operating conditions, the results from the pilot-scale MBR system validate the benefits of pure oxygen comparing to an air blower, which was identified and evaluated at lab-scale experiments using the system shown in FIG. 1 and/or FIG. 2.

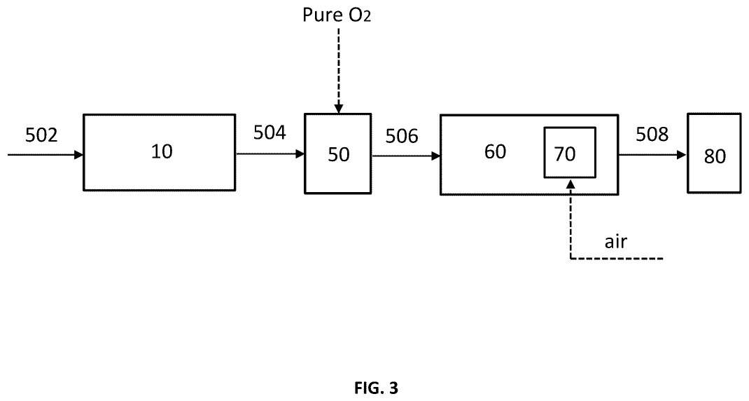

FIG. 3 is a block flow diagram of an exemplary embodiment of an aerobic or oxic MBR pilot system, which is used to treat high COD wastewater, more specifically, to treat high concentration of COD, low concentrations of nitrogen and phosphorus of wastewater. As shown, the aerobic MBR pilot system is a submerged pilot-scale MBR system with a working volume of around 2.8 m³ for treating high concentration of wastewater, such as brewery wastewater generated by brewing Companies. The aerobic MBR pilot system consists of one oxic basin or tank (2 m³) 50 and one membrane basin or tank (0.8 m³) 60. Here, pure oxygen gas is used to blow into the oxic basin 50. Feed wastewater 502 is collected in a septic tank and equalization basins, shown here as a block 10, to adjust the concentration of COD of wastewater prior to the oxic basin 50. Alkaline or acids may be used to neutralize feed wastewater between the septic tank and the equalization basins. The sludge stream 504 from the septic tank and equalization basins is forwarded to the oxic basin 50 for removing the COD. The membrane basin 60 includes a plurality of the micro-porous membrane module 70, preferably, two micro-porous membrane modules, submerged in the membrane basin 60. The membrane basin 60 includes a coarse bubble air diffuser (not shown), placed at the bottom of the membrane modules 70, to generate a cross-flow of air bubbles with air blown into the membrane basin 60 to scour a sludge flocs deposited on membrane surfaces of the membrane modules 70. The membrane modules 70 may be a flat-sheet membrane module, a hollow fiber membrane module, or the like, and the same as the membrane modules 70 shown in FIG. 1 and FIG. 2. A sludge stream 506 after the oxic basin 50 is forwarded to the membrane basin 60. For the pilot-scale operation, a flow rate of wastewater, a normal membrane flux, and membrane filtration modes may be set, and neutral pH level may be maintained in the system. It has been observed that pure oxygen used in the oxic basin 50 may lower the Zeta potential of sludge suspension and increase the electrostatic repulsion of foulants. Membrane fouling rate may be reduced to 56-70% compared to air without neither maintenance nor full recovery cleaning events required using the pure oxygen in the oxic basin 50. Using the pure oxygen in the oxic basin 50, the wastewater COD removal efficiency in colder temperatures (such as from September to November in Northern Hemisphere) may be comparable to the one using air. Frequent foaming issues happen using air blower in the oxic basin 50, but it is completely resolved with pure oxygen in the oxic basin 50. A treated wastewater stream 508 is transported to a discharge 80 for collection.

In some embodiments, the pure oxygen used in the oxic basin 50 may be from a liquid oxygen cylinder. Depending on the size of wastewater treatment facility, other oxygen sources, such as micro-bulk or bulk oxygen, may be used for oxygen injection to the MBR system.

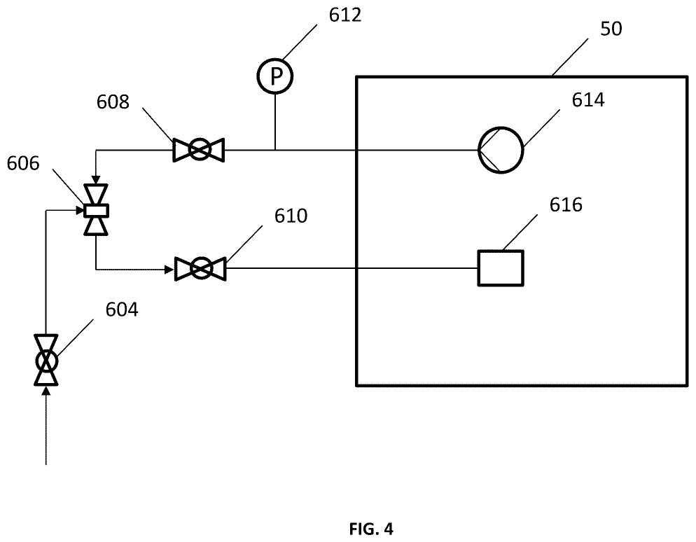

Devices for the pure oxygen injection to the MBR system may be a side-streaming system, a submerged diffuser, or a turbine aerator depending on the size of applications. In one embodiment, a side-streaming system is applied to inject pure oxygen as shown in FIG. 4. A Venturi injector 606 is connected with an internal recirculation line to provide oxygenated sludge back to an oxic basin 50. A PLC (not shown) is designed and installed to control the dissolved oxygen (DO) concentration in the oxic basin 50. A feed oxygen control valve 604 provides pure oxygen gas to a venturi injector 606. The internal circulation line includes a submersible recirculation pump 614 and a pressure gauge 612, a water flow control valve 608, an oxygenated sludge flow control valve 510, and a gas diffuser 616. Oxygen and the recirculated suspension are mixed through the venture injector 606. The pressure gauge 612 monitors water inlet pressure to make sure efficient oxygen dissolution into the suspension in the oxic basin 50. The water flow control valve 608 controls the suspension flow rate. The oxygenated sludge flow control valve 610 controls the oxygenated sludge recirculation flow rate. The submersible recirculation pump 614 may be a sludge suspension suction pump or the like. The gas diffuser 616 may be a Y-type gas diffuser or other types of diffusers commonly used in the art or specifically designed for the applications.

Compressed air blowers supplied coarse air bubbles to scour the surfaces of the membrane modules 70 at a certain rate according to the instruction provided by a membrane manufacturer. Note here when the permeability of the membrane sharply declined below 40 LMH/bar, the chemical cleaning of the modules was conducted according to the instruction provided by the membrane manufacturer.

### EXAMPLES

The following non-limiting examples are provided to further illustrate embodiments of the invention. However, the examples are not intended to be all inclusive and are not intended to limit the scope of the inventions described herein.

### Example 1: Lab-Scale MBR System

A submerged MBR set-up with a working volume of 100 L of feed synthetic wastewater that imitates wastewater was constructed. The entire set-up included an anaerobic selector (2 L), an anaerobic reactor (16 L), an anoxic reactor (20 L), an oxic reactor (40 L), and a membrane reactor (22 L). The average flow rate of the feed synthetic wastewater is 87-95 L/d and the feed synthetic wastewater contained 0.755 g/L peptone, 0.519 g/L meat extract, 0.0355 g/L urea, 0.019 g/L CaCl₂·H₂O, 0.0165 g/L K₂HPO₄, 0.009 g/L MgSO₄·7H₂O, and 0.45 g/L NaHCO₃. Table 2 summarizes the characteristics of the feed synthetic wastewater.

TABLE 2

| Parameters | Average Concentration | Units |
|---|---|---|
| COD | 1218 | mg O₂/L |
| TN | 151 | mg N/L |
| Ammonia | 61 | mg N/L |
| TP | 64 | mg PO₄³⁻/L |

An F/M ratio (food to microorganism ratio) and an organic loading rate (OLR) were maintained at 0.09 g COD/d MLSS·d and 0.11 kg COD/d on average. The recycling ratios were five for the internal recycling from the oxic to anoxic reactors and three for the external recycling from the membrane reactor to a selector. Effective hydraulic retention times (HRTs) considering sludge recycling were 0.1 hrs for buffer reactor, 0.67 hours for anaerobic reactor, 0.55 hours for anoxic reactor, 1.1 hours for oxic reactor, and 1.0 hours for membrane reactor, respectively. Total HRT was 3.4 hours and a sludge retention time (SRT) was about 54 days at a steady operating period.

The normal membrane flux was 14 L/m²·h (LMH) except for the period of severe biofouling. The membrane filtration mode was 5.25 min (pump on)/0.75 min (pump off). Compressed air was supplied through a fine air bubble diffusers at the bottom of the membrane cassette and the scouring rate was maintained at 0.95 Nm³/hr. A PLC was used to control the dissolved oxygen (DO) concentration in the oxic reactor and the MLSS height in membrane reactor. An ultrasonic level sensor and a polarographic DO sensor were connected with a process controller. The permeate pump was on/off depending on the set-point of MLSS height range in membrane reactor. A mass flow controller adjusted the gas supply rates of air or oxygen based on the target DO level for the oxic reactor. When the permeability of membrane sharply declined due to biofouling, the sludge cake deposited on membrane surface was physically washed out with tap water and the clogged bio-foulants was chemically cleaned by spraying 5% v/v of NaOCl solution.

### Example 2: Microbial SMP Assay as Membrane Bio-Foulant

The concentrations of SMP in the MBR were measured to quantify the extent of biofouling during the system operation. The activated sludge sample was first centrifuged at 6000 g for 10 minutes and supernatant was recovered as the SMP fraction.

The final sample was prepared by filtering all collected supernatant through a 0.45 μm glass fiber filter paper.

The protein and carbohydrates contents in the filtrates were measured according to the following methods. Total protein was determined using a modified Lowry method (Lowry et al., 1951). Three Lowry reagents were prepared: Reagent 1 (0.1 N NaOH and 2% (w/v) Na₂CO₃ in DI water), Reagent 2 (1% (w/w) NaKC₄H₄O₆·4H₂O and 0.5% (w/v) CuSO₄·5H₂O in DI water) and Reagent 3 (2N Folin-Phenol solution in DI water in 1:1 ratio). The Lowry solution was prepared by mixing 500 mL of Reagent 1 and 10 mL of Reagent 2. A sample (1.5 mL) and Lowry solution (2.1 mL) were mixed and incubated at room temperature for 20 minutes in the dark. After the incubation, Reagent 3 (0.3 mL) was added to the mixture and the second incubation was conducted for 30 minutes at room temperature in the dark. The absorbance of the final sample was measured at 750 nm using a spectrophotometer. Bovine serum albumin was used as the standard chemical to obtain a calibration curve for the protein assay.

The anthrone method (Frøloud et al., 1996) was used to measure the total carbohydrates. The anthrone reagent was prepared by dissolving 1 g of anthrone in 500 mL of 75% (v/v) H₂SO₄ solution. Filtered samples, H₂SO₄ solution, and the anthrone reagent were mixed at a volume ratio of 1:2:4 in a glass tube. The mixture was heated at 100° C. for 15 minutes and the absorbance of the heated sample was measured at 578 nm by a spectrophotometer. The calibration curve for the total carbohydrates was determined using glucose as the standard chemical. The SMP concentrations in the membrane reactor are shown in Table. 3.

### Example 3: Confocal Laser Scanning Microscopy (CLSM) Analysis

The membrane surface roughness was analyzed using a CLSM system. Two probes were used to observe the surfaces of bio-fouled membrane: dye Concanavalin A Alexa Flour 488 conjugate (5 mg, Invitrogen) to target polysaccharides and dye SYPRO orange (5000× concentrate in DMSO, Invitrogen) to target proteins. The membrane specimen was cut in 10 mm×10 mm and stained with the probes. The stained membrane sample was incubated in the dark at room temperature for 30 minutes. After incubating, the membranes were washed out with a PBS solution. The prepared membrane sample was placed on the stage focus for observation. Fluorescence signals were detected in the green channel (excitation 488 nm and emission 570 nm) for proteins and the red channel (excitation 633 nm and emission 647 nm) for polysaccharides. The image analysis was conducted with the collected microscopic data using an image software (ZEN Imaging Software, Carl Zeiss Inc., Germany). The results of biofouled membrane surface roughness are shown in Table. 3.

### Example 4: Membrane Permeability Loss Rate

The daily permeability of membrane was calculated by dividing the average permeate flux (LMH) by the average daily transmembrane pressure (TMP, bar). The decreasing rate of the daily permeability was defined as the membrane permeability loss rate (LMH/bar·day). The results of membrane permeability loss rate are shown in Table. 3.

### Example 5: Biological Oxygen Uptake Rate

The volumetric mass transfer coefficient (K_{La}) in oxic bioreactor was determined to evaluate the oxygen transfer rate using air or pure oxygen. All pumps including feed, recycling, and permeate pumps were turned off and the DO concentration profile was monitored while maintaining the feed air/pure oxygen supply rate at the operating level. The DO concentration increases due to no more biological oxygen uptake and then reached to the saturation level. During this period of the batch test, the oxygen mass balance for oxygen transfer rate (OTR) in the oxic reactor may be expressed as follows:

$$\frac{d C}{d t} = {K}_{L} a ( {C}_{S} - C ) = OTR$$

where C is the oxygen concentration at time=t, Cₛ is the saturation concentration of oxygen.

Integrating the above equation yields:

$$ln ( {C}_{S} - C ) = - {K}_{L} a \cdot t$$

Thus, the −K_{La} value should be a linear slope of a plot of ln(Cₛ−C) vs. t.

When −K_{La} value is known, steady-state OUR may be determined using the above equation at dC/dt=0 under the operating DO condition (C=C₀) as follow:

$${K}_{L} a ( {C}_{S} - {C}_{0} ) = OUR$$

The results of oxygen uptake rate are shown in Table. 3.

### Example 6: Water and Sludge Samples Analysis

A spectrophotometer was used to measure phosphate. MLSS were determined according to Standard Methods (APHA et al., 2005). Samples were collected from the buffer, anaerobic, anoxic, oxic, and membrane reactors. The results of phosphate released in anaerobic reactor versus phosphate uptaken in aerobic (or oxic) reactor are shown in Table. 3.

In summary, various data in Table. 3 show that by using pure oxygen the membrane permeability is improved at least 2 times comparing to using air.

TABLE 3

| | | Pure O₂ | |
|---|---|---|---|
| Parameters | Air MBR | MBR | Units |
| Oxygen uptake rate (OUR) | 27.8 | 41.1 | mg/L · hr |
| SMP concentration in MBR | 134 | 108 | mg/g MLSS |
| Biofouled membrane | 21.1 | 13.1 | μm |
| surface roughness | | | |
| P release in anaerobic/ | 73.0/12.9 | 90.6/9.5 | mg/L |
| P uptake in membrane reactor | | | |
| Membrane permeability loss rate | 37.5 | 16.1 | LMH/bar · day |

The disclosed pure oxygen-based MBR wastewater treatment system presents the following advantages.
1) enabling wastewater microorganisms to treat biodegradable organic contaminants including COD, P, N and membrane foulants using pure oxygen faster than that using bulk air;
2) reducing the membrane fouling rate and improving the membrane permeability by reducing the membrane foulant deposition on the membrane surface submerged in the membrane basin;
3) consuming less oxygen molecules for the biological oxidation through using high purity oxygen gas to wastewater microorganisms, and
4) ensuring a stable nutrients (e.g., phosphorus, nitrogen) removal in treating wastewater through setting up buffer, anaerobic, anoxic, oxic, and submerged membrane basins in series with returning sludge stream from the oxic basin to the anoxic basin and/or from the submerged membrane basin to the buffer basin.

### Example 7: Wastewater Treatment with a Pilot-Scale MBR System

### MBR System Operation

Two membrane modules with pore size 0.04 um were used to treat wastewater. The effective area of the total membrane was 25 m². The pilot-scale MBR system shown in FIG. 3, having a working volume of 2.8 m³, was used to treat high COD brewery wastewater. Table 4 summarizes the characteristics of synthetic wastewater that mimic real brewery wastewater. The flow rate of wastewater was 4.3 m³/day at the steady-state operation and the normal membrane flux was 8.95 L/m²·h (LMH). The membrane filtration mode was 5 min-on/5 min-off at a normal operation with high COD wastewater and 3 min-on/5 min-off with relatively low COD wastewater comparing to the normal operation.

TABLE 4
Feed wastewater characteristics

| Parameters | Units | Average Concentration |
|---|---|---|
| COD | mg COD/L | 4123 |
| BOD | mg BOD/L | 2545 |
| TN | mg N/L | 90.8 |
| Ammonia | mg N/L | 24.4 |
| TP | mg PO₄³⁻/L | 24.0 |

Two biological aeration regimes, that is, using air from an air blower and using pure oxygen from a liquid oxygen cylinder in the oxic basin 50, were compared during a period, such as 62 days of operation. An air blower was used for the biological aeration of the oxic basin 50 during an air test with fine bubble diffusers placed on the bottom of the oxic basin 50 to supply air provided by compressor. The blower capacity was 43 Nm³/hr to maintain a dissolved oxygen (DO) concentration between 4 and 6 mg/L at a steady operation period. For the oxygen test, the fine bubble diffusers were removed from the oxic basin 50 and a side-stream injection device was set to provide pure oxygen to the oxic basin 50 and the aeration source was switched to liquid oxygen cylinders. FIG. 4 is an exemplary side-streaming device that was applied to inject the pure oxygen from the liquid oxygen cylinders. A venturi injector 606 was connected with an internal recirculation line to provide oxygenated sludge back to the oxic basin 50. Sludge recirculation rate was 10 m³/hr and an inlet pressure of the venturi injector was 2 barg shown in the pressure gauge 612 to keep sludge suspension mixed in the oxic basin 50. The PLC (not shown) controlled the dissolved oxygen (DO) concentration in the oxic basin 50. The DO concentration for the oxygen test was set to 5 mg/L. Compressed air blowers supplied coarse air bubbles to scour the surfaces of the membrane modules 70 at a rate of 2.5-5 Nm³/hr/module according to an instruction provided by a membrane manufacturer. Note here, when the permeability of the membrane sharply declined below 40 LMH/bar, the chemical cleaning of the modules was conducted according to the instruction provided by the membrane manufacturer.

Food to microorganisms (F/M) ratio and an organic loading rate (OLR) were maintained at between 0.5 and 2.5 g COD/g MLSS·d and 8.5 and 11 kg COD/d. A sludge recycling rate from the membrane basin 60 to the oxic basin 50 was 86.4 m³/day. A hydraulic retention time (HRT) was about 15.6 hours during the pilot test period.

### Membrane Permeability Determination

The membrane permeability (LP) was calculated by dividing the daily permeate flux (J) by the daily applied transmembrane pressure (TMP).

$${L}_{P} = \frac{J}{TMP}$$

where L_{P} is the membrane permeability (LMH/bar), J is the daily membrane permeate flux (LMH; liter/m²·hr), and transmembrane pressure (TMP) is the pressure difference (bar) between the permeate pump-on and -off.

Temperature affects the viscosity of water. In the MBR process, the change in the viscosity of the membrane permeate water impacts directly the TMP level. The following equation was used to correct the membrane permeability for the temperature effect.

$${L}_{P}^{20 ° C .} = \frac{J \cdot {e}^{( - 0.0239 ( T - 20 ) )}}{TMP}$$

where L_{P}^{20° C.} is the temperature-corrected membrane permeability (LMH/bar) and T is the permeate water temperature (° C.).

### Water and Sludge Samples Analysis

A spectrophotometer was used to measure COD, TN, ammonia, and TP to monitor the wastewater removal efficiency. Total COD (TCOD) was defined as COD of the entire sample, whereas SCOD was defined as COD of filtrate through filters with a nominal pore size of 0.45 μm. MLSS were determined according to Standard Methods (APHA et al., 2005). The DO concentration, temperature and pH values were measured using a portable commercially available meter. A Zeta potential of sludge sample in the oxic basin was measured to elucidate the interaction between bioflocs and the membrane surfaces during the membrane fouling. The OUR of aerobic microorganisms in the oxic basin 50 was measured to evaluate a biological oxygen usage efficiency in the oxic basin 50. The sludge sample in the oxic basin 50 was collected in a glass bottle for DO measurements. The DO concentration was recorded every five seconds and the OUR value (mg/L hr) was calculated by determining the slope of the linear portion of the DO curve over time. The specific OUR (SOUR) was determined by dividing the OUR values by the MLSS concentrations and corrected to 20° C. according to the following equation.

SPUR₂₀=SOUR_{T}×θ^{(20-T)}

where SOUR₂₀ is the specific oxygen uptake rate at 20° C. (mg O²/g MLSS·hr), SOUR_{T} is the specific oxygen uptake rate in the sample, T is the temperature of the sample during analysis (° C.), and θ is the temperature correction factor (1.05 above 20° C. and 1.07 below 20° C.).

### Results and MBR Pilot Performance

The MBR pilot operation became stable with the system modification to feed high COD wastewater as mentioned in the previous section. The concentration of COD of feed wastewater gradually increased and reached a steady state after a certain period, such as ˜ 90 day of operation. The Key summary of pilot operation data, membrane fouling mitigation using pure oxygen, are as follows.

### Alteration of Sludge Suspension-to-Membrane Surface Interaction:

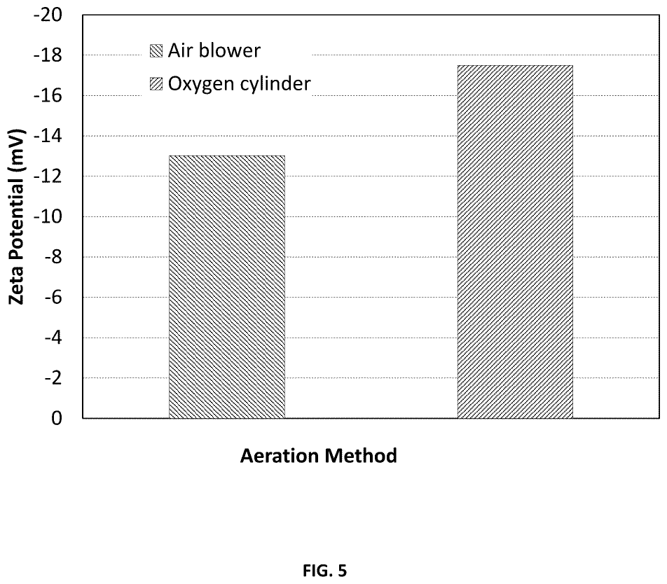

Pure oxygen changed the surface chemistry of suspension and manipulated the interaction between suspension and the membrane surfaces in a favorable condition to decrease the steady membrane fouling rate. Less amount of sludge suspension was deposited on the membrane surfaces, resulting in lower TMP build-up rate during the pure oxygen test. One of factors affecting the membrane fouling is the zeta potentials of suspension and the membrane surfaces. The sludge samples aerated by pure oxygen were more negatively charged than the ones aerated by the air blower (see FIG. 5). The PVDF membrane surfaces possess high negative charges, which increases the electrostatic repulsion of high negatively charged foulants. During the initial steady fouling stage, less foulants with a high negative charge adheres to the membrane surface.

### Suppression of Foaming Bacteria:

Foaming phenomenon often relates to the membrane fouling in the MBR applications. Production of foam is attributed to the development of and attachment of filamentous bacteria with hydrophobic cell surfaces and membrane fouling-causing extracellular polymeric substance (EPS) to air bubbles in aerobic systems. The utilization of slowly biodegradable organics such as lipids, proteins, and fats by filamentous microorganisms is believed to cause foaming issues. Filamentous bacteria become dominant in low DO and low F/M ratio conditions. High purity oxygen is considered to control foaming issues because of its high dissolution capacity and flowrate into wastewater. The pilot system had faced frequent foaming issues with loss of biomass during the air test. After switching the air blower to the oxygen venturi injector for the oxygen test, foaming events were no longer present in the oxic basin 50. It gave additional benefits of using pure oxygen in terms of saving the chemical cost for defoaming and the membrane costs associated with cleaning and replacement.

### Membrane Fouling Rate Reduction by Pure Oxygen:

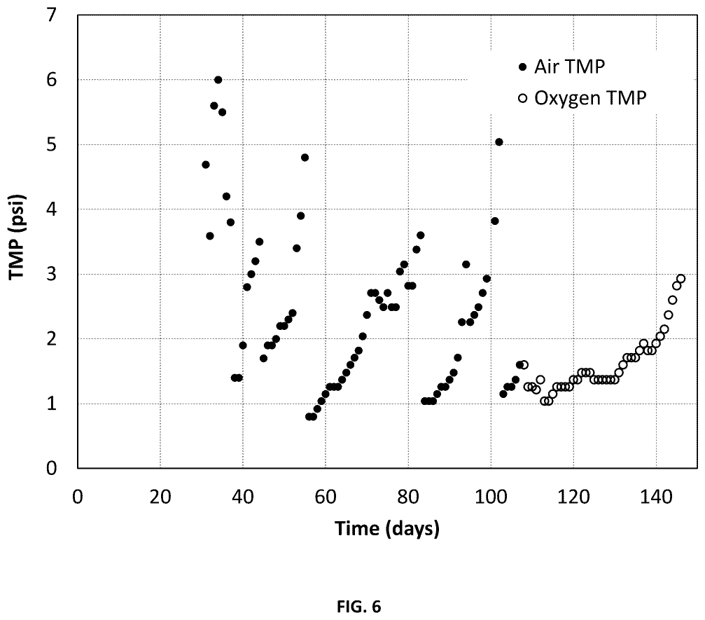

The membrane fouling rate was reduced by 56-70% (from 0.099 psi/day for the 1st air test cycle and 0.143 psi/day for the 2nd air test cycle to 0.043 psi/day for pure oxygen cycle) without any maintenance and full recovery cleaning events during the pure oxygen test (see FIG. 6).

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1-37. (canceled)

38. A system for treating a wastewater that contains high concentration of chemical oxygen demand (COD), high concentration of nitrogen and high concentration of phosphorus to yield a low COD output along with a low phosphorous output and a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
an anaerobic tank, located downstream of, and being fluidically connected to, the buffer tank, comprising the buffered sludge stream, configured and adapted to release a phosphorous contained in the buffered sludge stream to phosphate ions (PO₄³⁻) by phosphorus accumulating organisms (PAOs) in the anaerobic tank yielding a phosphorous-released sludge stream;
an anoxic tank comprising the phosphorous-released sludge stream and located downstream of, and being fluidically connected to the anaerobic tank, configured and adapted to enable uptake of the released phosphate ions (PO₄³⁻) contained in the phosphorous-released sludge stream by wastewater microorganisms in the anoxic tank, yielding a low phosphorous output sludge stream;
an oxic tank, located downstream of, and being fluidically connected to the anoxic tank, comprising the low phosphorous output sludge stream and a pressurized pure oxygen, the oxic tank configured and adapted to enable a further oxidization of the soluble organic components contained in the low phosphorous output sludge stream and to convert the nitrogen contained in the low phosphorous output sludge stream to nitrate ions;
an internal sludge recycle line fluidically connecting the oxic tank and the anoxic tanks, the internal sludge recycle line configured and adapted to recycle a nitrate-enriched liquor from the oxic tank as an internal sludge recycle stream to the anoxic tank for denitrification, thereby, yielding a low COD output, low nitrogen output and low phosphorous output sludge stream from the oxic tank;
an injection subsystem operably connected to the oxic tank and configured and adapted to inject the pressurized pure oxygen into the oxic tank;
a membrane bioreactor tank, located downstream of and being fluidically connected to the oxic tank, comprising the low COD output, low nitrogen output and low phosphorous output sludge stream and a plurality of membrane modules submerged in the low COD output, low nitrogen output and low phosphorous output sludge stream, the plurality of membrane modules configured and adapted to filter out a treated wastewater having the low COD output, low phosphorous output and low nitrogen output thereby forming the sludge stream; and
a sludge recycle line configured and adapted to recycle at least a portion of the sludge stream containing the residual dissolved oxygen back to the buffer tank.

39. The system of claim 38, wherein the buffer tank further comprises PAOs therein and wherein the phosphorous contained in the liquid phase of the wastewater is also capable of being released to the phosphate ions (PO₄³⁻) by the PAOs in the buffer tank.

40. The system of claim 38, wherein the pressurized pure oxygen has a purity of 99.99% by volume.

41. The system of claim 40, wherein a dissolved oxygen concentration in the oxic tank ranges from approximately 2 mg/L to approximately 6 mg/L.

42. The system of claim 38, wherein the membrane module is a flat-sheet membrane module or a hollow fiber membrane module.

43. The system of claim 38, wherein a mixed liquor suspended solids in the membrane tank is between approximately 8000 mg and approximately 15000 mg of total suspended solids per liter.

44. A method for treating a wastewater that contains high concentration of COD, high concentration of nitrogen and high concentration of phosphorus to yield a low COD output along with a low phosphorous output and a low nitrogen output, the method comprising the steps of
a. mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b. releasing phosphorous contained in the liquid phase of the wastewater in the buffered sludge stream to phosphate ions (PO₄³⁻) in an anaerobic tank, thereby yielding a phosphorous-released sludge stream;
c. uptaking the released phosphate ions (PO₄³⁻) contained in the phosphorous-released sludge stream in an anoxic tank yielding a low phosphorous output sludge stream;
d. transferring the low phosphorous output sludge stream from the anoxic tank to an oxic tank, injecting pressurized pure oxygen into the oxic tank and recycling a nitrate-enriched liquor from the oxic tank as an internal sludge recycle stream to the anoxic tank for denitrification, thereby yielding a low COD output, low nitrogen output and low phosphorous output sludge stream from the oxic tank;
e. forwarding the low COD output, low nitrogen output and low phosphorous output sludge stream to a membrane bioreactor tank;
f. filtering out a treated wastewater having the low COD output, low phosphorous output and low nitrogen output with membrane modules submerged in the membrane bioreactor tank, thereby also producing the sludge stream; and
g. feeding the sludge stream containing the residual dissolved oxygen from the membrane bioreactor back to the buffer tank in the step a.

45. The method of claim 44, wherein a flow rate of the nitrate-enriched liquor recycled to the anoxic tank is approximately 5 times larger than a flow rate of the liquid phase of the wastewater feeding into the buffer tank, thereby maintaining a low concentration of nitrogen in the oxic tank.

46. The method of claim 44, wherein the pressurized pure oxygen has a purity of 99.99% by volume.

47. The method of claim 46, wherein a dissolved oxygen concentration in the oxic tank ranges from approximately 2 mg/L to approximately 6 mg/L.

48. The method of claim 44, wherein a sludge retention time is maintained between approximately 40 days to approximately 60 days.

49. The method of claim 44, wherein an average effective hydraulic retention time is between approximately 3 hours to approximately 5 hours.

50. A system for treating a wastewater that contains high concentration of COD, high concentration of nitrogen and low concentration of phosphorous to yield a low COD output along with a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
a nitrification and denitrification loop comprising
an anoxic tank comprising the buffered sludge stream and located downstream of, and being fluidically connected to, the buffer tank;
an oxic tank, located downstream of, and being fluidically connected to, the anoxic tank, comprising the buffered sludge stream and pressurized pure oxygen; and
an injection subsystem operably connected to the oxic tank and configured and adapted to inject the pressurized pure oxygen into the oxic tank,
wherein the nitrification and denitrification loop is configured and adapted to further oxidize soluble organic components contained in the buffered sludge stream and to convert the nitrogen contained in the buffered output sludge stream to nitrate ions by recycling a nitrate-enriched liquor from the oxic tank as an internal sludge recycle stream to the anoxic tank for denitrification, thereby, yielding a low COD output and low nitrogen output sludge stream;
a membrane bioreactor tank, located downstream of and being fluidically connected to the oxic tank, comprising the low COD output and low nitrogen output sludge stream and a plurality of membrane modules, the plurality of membrane modules configured and adapted to filter out a treated wastewater having the low COD output and low nitrogen output thereby forming the sludge stream; and
a sludge recycle line configured and adapted to recycle at least a portion of the sludge stream containing the residual dissolved oxygen back to the buffer tank.

51. The system of claim 50, wherein the pressurized pure oxygen has a purity of 99.99% by volume.

52. The system of claim 50, wherein a dissolved oxygen concentration in the oxic tank ranges from approximately 2 mg/L to approximately 6 mg/L.

53. A method for treating a wastewater that contains high concentration of COD, high concentration of nitrogen and low concentration of phosphorous to yield a low COD output along with a low nitrogen output, the method comprising the steps of:
a. mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b. feeding the buffered sludge stream to an anoxic tank fluidly connected to the buffer tank;
c. transferring the buffered sludge stream from the anoxic tank to an oxic tank, injecting pressurized pure oxygen into the oxic tank;
d. recycling a nitrate-enriched liquor from the oxic tank as an internal sludge recycle stream to the anoxic tank to convert the nitrogen contained in the buffered sludge stream to nitrate ions, thereby yielding a low COD output and low nitrogen output sludge stream from the oxic tank;
e. filtering out a treated wastewater having the low COD output and low nitrogen output with membrane modules submerged in a membrane bioreactor tank, thereby also producing the sludge stream; and
f. feeding the sludge stream containing the residual dissolved oxygen discharged from the membrane bioreactor back to the buffer tank in the step a.

54. The method of claim 53, wherein a flow rate of the nitrate-enriched liquor recycled to the anoxic tank is approximately 5 times larger than a flow rate of the liquid phase of the wastewater feeding into the buffer tank, thereby maintaining a low concentration of nitrogen in the oxic tank.

55. The method of claim 53, wherein the pressurized pure oxygen has a purity of 99.99% by volume.

56. The method of claim 53, wherein a dissolved oxygen concentration in the oxic tank ranges from approximately 2 mg/L to approximately 6 mg/L.

57. A system for treating a wastewater that contains high concentration of COD, low concentration of nitrogen and low concentration of phosphorous to yield a low COD output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream;
an oxic tank, located downstream of, and being fluidically connected to, the buffer tank, comprising the buffered sludge stream and pressurized pure oxygen, the oxic tank configured and adapted to enable a further oxidation of the soluble organic components contained in the buffer sludge stream, thereby, yielding a low COD output, low nitrogen output and low phosphorous output sludge stream;
a membrane bioreactor tank, located downstream of and being fluidically connected to, the oxic tank, comprising the low COD output, low nitrogen output and low phosphorous output sludge stream and a plurality of membrane modules, the plurality of membrane modules configured and adapted to filter out a treated wastewater having the low COD output, low phosphorous output and low nitrogen output thereby forming the sludge stream; and
a sludge recycle line configured and adapted to recycle at least a portion of the sludge stream containing the residual dissolved oxygen back to the buffer tank.

58. The system of claim 57, wherein the pressurized pure oxygen has a purity of 99.99% by volume.

59. The system of claim 57, wherein a dissolved oxygen concentration in the oxic tank ranges from approximately 2 mg/L to approximately 6 mg/L.

60. A method for treating a wastewater that contains high concentration of COD, low concentration of nitrogen and low concentration of phosphorous to yield a low COD output, the method comprising the steps of:
a. mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b. transferring the buffered sludge stream from the buffered tank to an oxic tank, simultaneously injecting pressurized pure oxygen into the oxic tank, thereby yielding a low COD output, low nitrogen output and low phosphorous output sludge stream from the oxic tank;
c. filtering out a treated wastewater having the low COD output, low nitrogen output and low phosphorous output sludge stream with membrane modules submerged in a membrane bioreactor tank, thereby also producing the sludge stream; and
d. feeding the sludge stream containing the residual dissolved oxygen from the membrane bioreactor back to the buffer tank in the step a.

61. The method of claim 60, wherein the pressurized pure oxygen has a purity of 99.99% by volume.

62. The method of claim 60, wherein a dissolved oxygen concentration in the oxic tank ranges from approximately 2 mg/L to approximately 6 mg/L.

63. A system for treating a wastewater that contains high concentration of COD, low concentration of nitrogen and high concentration of phosphorous to yield a low COD output along with a low phosphorous output and a low nitrogen output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream and to release phosphorous contained in the liquid phase of the wastewater to phosphate ions (PO₄³⁻) by phosphorus accumulating organisms (PAOs), thereby, forming a buffered low phosphorous output sludge stream;
an oxic tank, located downstream of, and being fluidically connected to, the buffer tank, comprising the buffered low phosphorous output sludge stream and pressurized pure oxygen, the oxic tank configured and adapted to enable a further oxidation of the soluble organic components contained in the buffered low phosphorous output sludge stream, thereby, yielding a low COD output, low nitrogen output and low phosphorous output sludge stream;
an injection subsystem operably connected to the oxic tank and configured and adapted to inject the pressurized pure oxygen into the oxic tank;
a membrane bioreactor tank, located downstream of and being fluidically connected to the oxic tank, comprising the low COD output, low nitrogen output and low phosphorous output sludge stream and a plurality of membrane modules, the plurality of membrane modules configured and adapted to filter out a treated wastewater having the low COD output, low phosphorous output and low nitrogen output thereby forming the sludge stream; and
a sludge recycle line configured and adapted to discharging recycle at least a portion of the sludge stream containing the residual dissolved oxygen back to the buffer tank.

64. The system of claim 63, wherein the pressurized pure oxygen has a purity of 99.99% by volume.

65. The system of claim 63, wherein a dissolved oxygen concentration in the oxic tank ranges from approximately 2 mg/L to approximately 6 mg/L.

66. A method for treating a wastewater that contains high concentration of COD, low concentration of nitrogen and high concentration of phosphorous to yield a low COD output along with a low phosphorous output, the method comprising the steps of:
a. mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater and to release phosphorous contained in the liquid phase of the wastewater to phosphate ions (PO₄³⁻), thereby, forming a buffered low phosphorous output sludge stream;
b. transferring the buffered low phosphorous output sludge stream from the buffered tank to an oxic tank, simultaneously injecting pressurized pure oxygen into the oxic tank to oxidize the soluble organic components contained in the buffered low phosphorous output sludge stream, yielding a low COD output and low phosphorous output sludge stream from the oxic tank;
c. filtering out a treated wastewater having the low COD output and low phosphorous output with membrane modules submerged in the membrane bioreactor tank, thereby also producing the sludge stream; and
d. feeding the sludge stream containing the residual dissolved oxygen from the membrane bioreactor back to the buffer tank in the step a.

67. The method of claim 66, wherein the pressurized pure oxygen has a purity of 99.99% by volume.

68. The method of claim 66, wherein a dissolved oxygen concentration in the oxic tank ranges from approximately 2 mg/L to approximately 6 mg/L.

69. A system for treating a wastewater that contains high concentration of COD to yield a low COD output, the system comprising:
a buffer tank configured and adapted to mix a liquid phase of the wastewater with a sludge stream containing a residual dissolved oxygen to reduce soluble organic components in the liquid phase of the wastewater by consuming the residual dissolved oxygen in the sludge stream, thereby, forming a buffered sludge stream; and
a membrane bioreactor tank, located downstream of and being fluidically connected to, the buffer tank, comprising the buffered sludge stream, a plurality of membrane modules submerged in the buffer sludge stream and pressurized pure oxygen, the membrane bioreactor tank configured and adapted to i) further oxidize the soluble organic components contained in the buffered sludge stream forming the low COD output, ii) to filter out a treated wastewater having the low COD output, and iii) to discharge the sludge stream containing the residual dissolved oxygen recycled back to the buffer tank via a sludge recycle line.

70. The system of claim 69, wherein the pressurized pure oxygen has a purity of 99.99% by volume.

71. The system of claim 69, wherein a dissolved oxygen concentration in the oxic tank ranges from approximately 2 mg/L to approximately 6 mg/L.

72. A method for treating a wastewater that contains high concentration of COD to yield a low COD output, the method comprising the steps of:
a. mixing a liquid phase of the wastewater with a sludge stream containing a residual dissolved oxygen in a buffer tank to secure an oxygen-free buffered sludge stream by consuming the residual dissolved oxygen in the sludge stream with soluble organic components in the liquid phase of the wastewater, thereby, forming a buffered sludge stream;
b. transferring the buffered sludge stream from the buffered tank to a membrane bioreactor tank, simultaneously injecting pressurized pure oxygen into the membrane bioreactor tank, thereby yielding a low COD output sludge stream therein;
c. filtering out a treated wastewater having the low COD output with membrane modules submerged in the membrane bioreactor tank, thereby also producing the sludge stream; and
d. feeding the sludge stream containing the residual dissolved oxygen from the membrane bioreactor back to the buffer tank in the step a.

73. The method of claim 72, wherein the pressurized pure oxygen has a purity of 99.99% by volume.

74. The method of claim 72, wherein a dissolved oxygen concentration in the oxic tank ranges from approximately 2 mg/L to approximately 6 mg/L.
